(19) United States
(12) Patent Application Publication
(10) Pub. No.: US 2007/0061181 A1
(43) Pub. Date: Mar. 15, 2007

(54) System and method for construction planning

(75) Inventors: Donald L. Bowden JR., Cordova, TN (US); Jerri L. Gorman, Cordova, TN (US)

Correspondence Address: KIRKPATRICK & LOCKHART NICHOLSON GRAHAM LLP, STATE STREET FINANCIAL CENTER, One Lincoln Street, BOSTON, MA, 02111-2950, US

(73) Assignee: Gorbo Holdings, LLC, Cordova, TN (US)

(21) Appl. No.: 11/224,566

(22) Filed: Sep. 12, 2005

(51) Int. Cl. G06F 9/46

(52) U.S. Cl. 705/8

(57) ABSTRACT

Systems and methods for construction planning, including the take-off process, estimating, specification and merchandising of resources used in construction projects, are disclosed. In one embodiment, an object class for each of a plurality of resources is created. Resources are the materials, equipment and labor that are required to complete a construction project. Each object class represents an absolute property of each resource. One or more specification classes for each resource are also created, wherein the specification classes represent discretionary properties of each resource. Each specification class is associated with a corresponding object class for each resource. A take-off of the plurality of resources is estimated based on the object class of each resource in combination with a selected specification class associated with an object class for each resource. Alternative take-offs of the plurality of resources may be estimated based on alternate specification classes in combination with the object class of each resource.

### BACKGROUND

1. Field

The technical field of this invention relates to systems and methods for construction planning, including the estimating, specification and merchandising of construction projects.

2. Description of Related Art

In construction projects, a construction planning process is conducted before any actual construction begins. The construction planning process may typically include the tasks of performing take-offs, product specification and product merchandising.

A take-off is a process in which detailed lists may be compiled, based on drawings and specifications, of all the resources, including material, equipment and labor, necessary to construct a project. An estimator may use the lists to estimate how much it will cost to build the construction project. The term “take-off” may also refer to the lists generated in the take-off process, including the costs of each resource and the total cost of the project.

In product specification, the physical properties of selected resources are detailed. Resources are selected and fixed from a variety of choices offered in the marketplace. For example, a window may be selected and fixed from options for windows, such as a wood, vinyl or aluminum finish.

In product merchandising, the project as specified is marketed for sale. Product merchandising may be determined based on marketing considerations. For example, if the construction project is a subdivision of houses, the builder may design and specify the subdivision at a level that competes favorably with adjacent subdivisions. To offer choice, a builder may design and specify a number of models, from, for example, basic to deluxe, or with different styles such as Tudor or Colonial. Once the choices are fixed in the design and specification stage, the choices are not easily changed in response to buyer preferences or other conditions.

The tasks of estimating take-offs, product specification and product merchandising are typically combined in current construction planning tools, with each task dependent on one or both of the other tasks. The codependency of the tasks often hinders the construction planning process since completion of one task may depend upon the completion of the other tasks. The result is that the construction planning process is typically conducted in a cyclical, iterative manner, which leads to inefficiencies and delays in the construction planning process. Also, design and specification are fixed and not flexible when sales begin.

These inefficiencies and delays are further exacerbated by changes that may arise in construction plans after one or more of the tasks have been completed. For example, in current systems a take-off may be estimated at the outset of the construction planning process that takes into account every detail of each resource involved in the construction project. Significant input from a builder, marketing director, or hypothetical customer, is required at the outset of the construction project to estimate the take-off. The input typically derives from the product specification and product design tasks. If changes to the details of the resources need to be implemented after the take-off has been estimated, a new take-off must be estimated taking into account all of the details of the resources, requiring additional time and effort in the construction planning process. This makes it economically difficult or impossible to change estimates and specifications for individual customers once the sales phase has begun.

In order to minimize inefficiencies in the construction planning process, new tools are needed to replace current construction planning tools that are inflexible to changes that arise in construction plans, since implementing such changes after one or more tasks have been completed may require that the tasks be re-performed at significant time and expense. Consequently, current construction planning tools are often cumbersome to use and may result in delay in the construction planning process.

For example, in current systems and methods for construction planning, resources are described in detail. For example, a window resource may be described as 3′×5′ in size and made from aluminum. In order to avoid having to re-estimate costly take-offs using current systems for construction planning, a commitment to selections regarding product specification details are required very early in the planning process. Additionally, subsequent changes to any such selections may be impossible or limited, even if it may be desirable or necessary to alter product specifications after the take-off process such as, for example, during the product merchandising stage or at a point of sale with a customer.

Accordingly, there is a need to effectively separate the tasks of performing take-offs, product design specification, product merchandising, and cost generation in construction planning to allow these tasks to progress in an independent, abstracted manner without reiteration. Additionally, there is a need to provide flexibility in the planning process of construction projects. Further, there is a need to efficiently accommodate changes in product take-off, and design specification, after an initial take-off is performed, and to allow for the evaluation of the impact of those changes on a construction project, such as, for example, at a point of sale with a customer.

### BRIEF DESCRIPTION OF THE DRAWINGS

The utility of the embodiments of the invention will be readily appreciated and understood from consideration of the following detailed description of the embodiments of this invention, when taken with the accompanying drawings, in which same numbered elements are identical or similar.

FIG. 1 illustrates an object diagram of a system for construction planning according to one embodiment;

FIG. 2 illustrates a flow diagram of a method for construction planning according to one embodiment;

FIG. 3 illustrates an object diagram of specification classes grouped into packages according to one embodiment;

FIG. 4 illustrates an object diagram of a computer system for implementing a system for construction planning according to one embodiment; and

FIG. 5 illustrates an exemplary listing of Construction Specification Institute (CSI) classifications.

### DETAILED DESCRIPTION

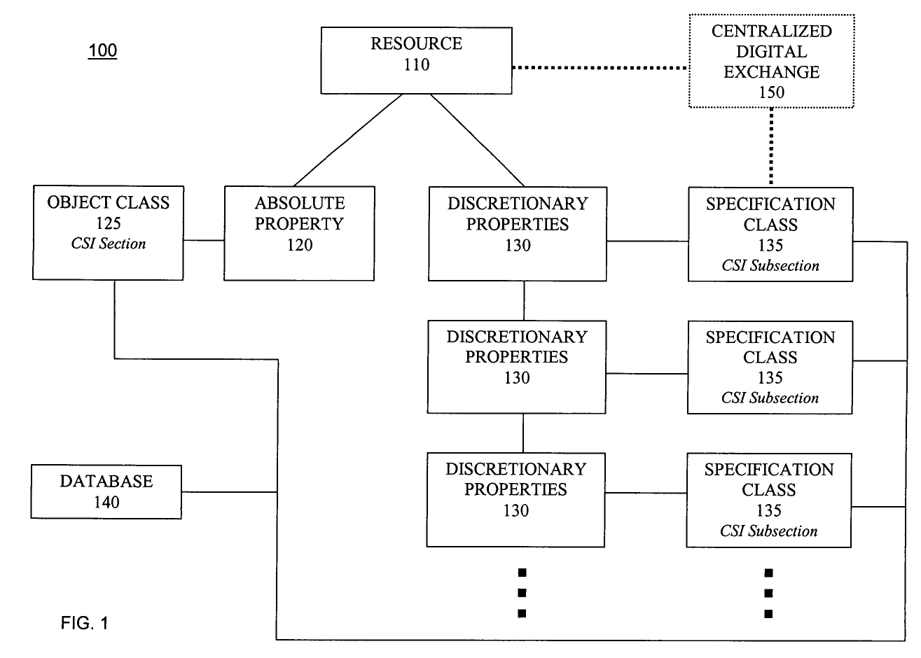

FIG. 1 illustrates an object diagram of a system 100 for construction planning according to one embodiment. Materials, equipment and labor used in construction projects are known as resources 110. For example, a resource may be a window or door used in the construction of a house. Each resource may have absolute properties 120 and discretionary properties 130.

Absolute properties 120 are characteristics of a resource 110 that are essential to the functionality of the resource 110 in the construction project. For example, an absolute property 120 of a window resource may be the size of the window. Discretionary properties 130 are qualitative characteristics of a resource 110 that may be altered without changing the functionality of the resource 110 in the construction project. For example, discretionary properties 130 of a window resource may include color, style (e.g., single pane, double pane, palladian), finish (e.g., vinyl, aluminum, wood), manufacturer (e.g., Andersen®, Pella®) and installation method. Therefore, a window resource may have an absolute property 120, such as dimensions of 3′×5′, and one or more discretionary properties 130, such as an aluminum finish and vinyl clad finish. For example, a window with a vinyl clad finish may be more expensive than a window with an aluminum finish of the same size.

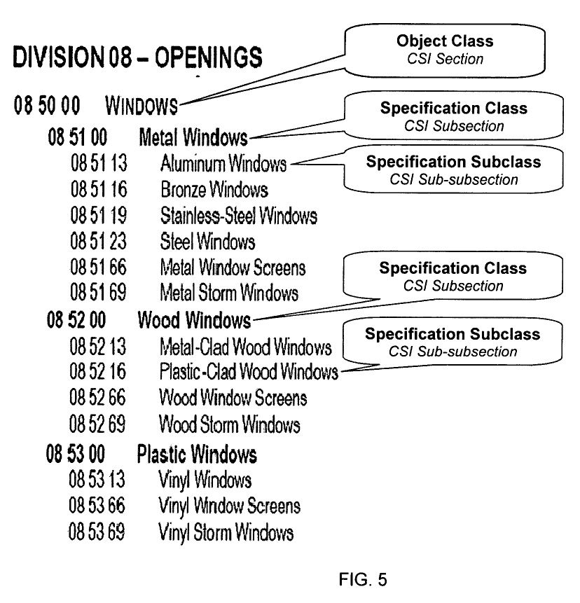

FIG. 5 illustrates an exemplary listing of industry-standard Construction Specification Institute (CSI) classifications. For example, a windows section may be broken down into various types of subsections, including metal windows, wood windows and plastic windows. Each subsection of windows may be further segregated into various sub-subsections, such as aluminum windows, bronze windows and stainless-steel windows under the metal windows subsection. By using CSI classifications, resources and their specification grades may be more easily integrated into a future “centralized” digital exchange 150. Product vendors, such as appliance manufacturers, that are maintaining web service-enabled electronic catalogs may be able to seamlessly integrate into the centralized digital exchange 150 as well as a back-office construction management system.

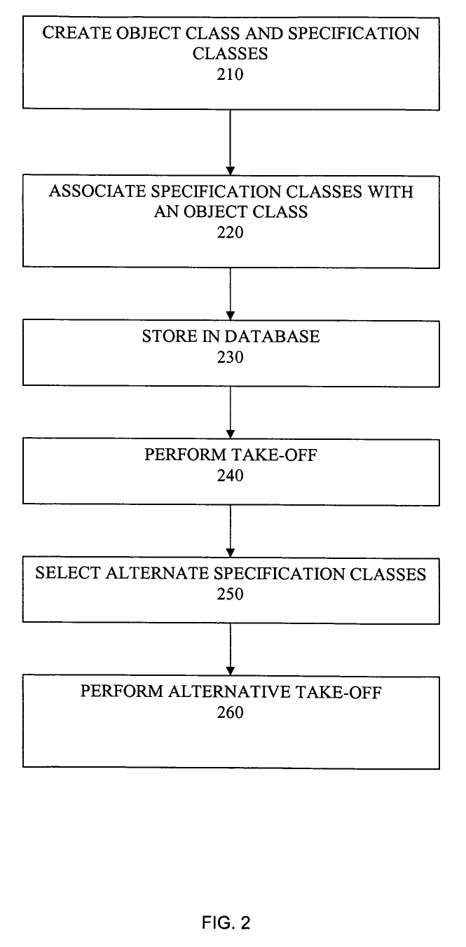

In one embodiment, as illustrated in FIGS. 1 and 2, an object class 125 (associated with a CSI section) and one or more specification classes 135 (associated with CSI subsections), may be created in step 210 for each resource 110 in the construction project. Each object class 125, represents an absolute property 120 of the resource 110. The specification classes 135 represent the discretionary properties 130 associated with the resource 110. Each object class 125 and specification class 135 corresponds to a cost that is based on the properties corresponding to each class. For example, a window resource with specification class representing an aluminum clad finish may have a lower cost than a window resource of the same size with a specification class representing a vinyl clad finish.

The specification classes 135 may be associated with the object class 125 for each resource 110 in step 220 as illustrated in FIG. 2. For example, for a window resource, a specific size of 3′×5′ (object class) may be associated with various levels of finish, such as vinyl, aluminum or wood (specification classes). The specification classes 135 and the object class 125 for each resource 110 may be stored in a database 140 in step 230.

A take-off of resources may be performed based on the object class 125 of each resource 110. An estimate, that includes cost data, is then produced from a selected specification class 135 associated with each object class 125 in step 240. The selected specification class may be a default or baseline specification class. As discussed above, estimating a take-off may involve compiling detailed lists of all the resources necessary for the construction project and estimating the costs of the resources involved. For example, the take-off estimate may include the cost of a 3′×5′ sized window with a first finish, color, style, manufacturer and installation method. An initial take-off may be estimated before product specification is performed, since the take-off is not dependent on selection of any specification classes 135. As a result, a builder, or customer, is not forced to commit to an early selection regarding product specifications of resources.

Alternate specification classes 135 may be selected for one or more resources 110 in step 250. Alternative take-offs may be performed based on the object class of each resource 110 and the selected alternate specification classes corresponding to each resource 110 in step 260. In one embodiment, take-offs may be performed by software utilizing the database 140 comprising the object classes 125, and the specification classes 135 associated with each object class 125, for the construction project. In order to estimate alternative take-offs, the software may replace one or more selected specification classes for each object class 125 with corresponding selected alternate specification classes associated with each object class 125 in the database 140, as appropriate. An estimation of the costs of the resources 110 in the take-off may then be recalculated in step 260.

Alternative estimates may be performed whenever selection of specification classes 135 are changed after the initial takeoff, such as, for example, during the product merchandising stage or at a point of sale with a customer. As a result, the builder, or customer at a point of sale, has the ability to consider various specification class choices associated with each resource after an initial take-off, and is able to see how the choices affect the overall price of the construction project. For example, a salesperson, at a point of sale, may use a laptop computer to access the software and the database 140 to quickly quote pricing on options using the alternate specification classes for the house selected by the customer at the point of sale. The point of sale may occur at a model home, design center, marketing web site, or a sales office, containing information about options offered for the house. The customer may then be able to see how various options affect the overall cost of the house.

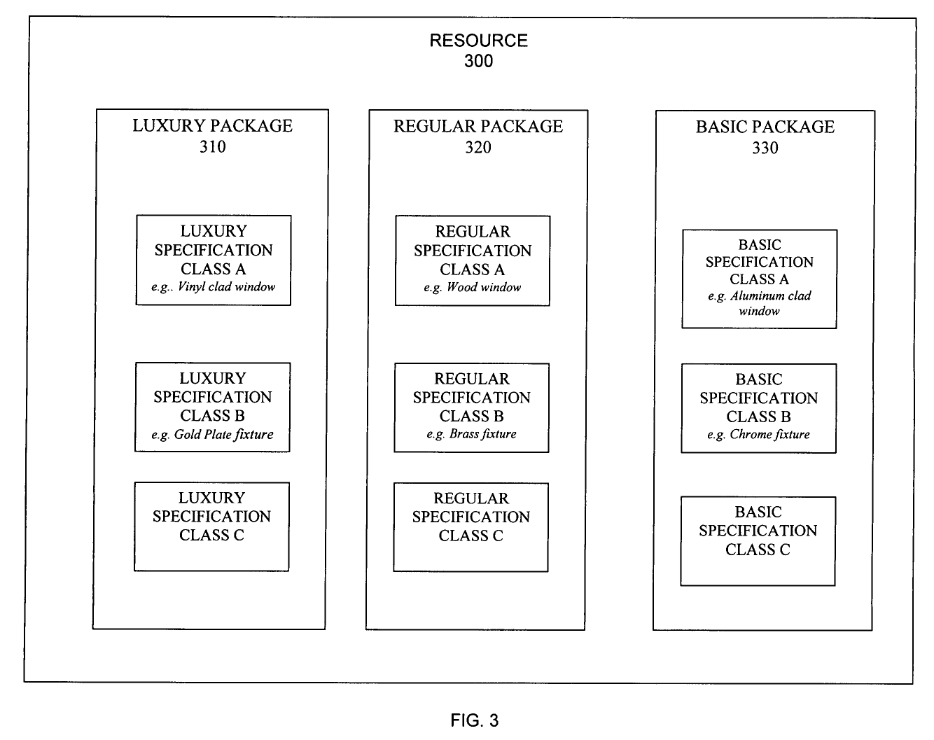

In one embodiment, as illustrated in FIG. 3, various combinations of specification classes may be grouped together into packages for one or more resources 300. For example, a luxury package 310, a regular package 320 and a basic package 330 may be created for a resource 300. Each package may be tailored to combine a plurality of specification classes 135 that share a similar level of cost, with respect to the discretionary properties of the resource 300. For example, the luxury package 310 may be selected for a window resource that may include luxury specification classes A, B and C, which represent the most expensive discretionary properties (e.g., finish, style, manufacturer) defined for the window resource (not shown). Similarly, the regular package 320 and the basic package 330 may include regular specification classes and basic specification classes, respectively, representing lower cost discretionary properties.

Alternatively, a luxury package 310, a regular package 320 and a basic package 330 may be created for a plurality of resources 300. For example, the luxury package 310 may include luxury specification A for vinyl clad windows, luxury specification B for gold plate fixtures, and other luxury specifications C. Similarly, regular package 320 may include specifications A for wood windows, B for brass fixtures, and other regular specifications C; and basic package 330 may include specifications A for aluminum clad windows, B for chrome fixtures, and other basic specifications C.

A package may be selected for one or more resources 110, and one or more take-offs may be estimated based on the selected packages corresponding to each resource 110, as described above with respect to FIG. 2. Each package for a resource 110 may correspond to a cost based on the combination of costs for the specification classes 135 in the package. Also, different packages may be selected for individual resources 110. For example, a luxury package may be selected for a window resource while a regular package may be selected for a fixture resource. Additionally, a combination of packages and individual specification classes 135 may be selected for the resources 110.

In one embodiment, a resource 110, including for example, materials, may be known as an element used in a construction project. An absolute property 120 of the element may be known as a fixed attribute, and a discretionary property 130 of the element may be known as an optional attribute. Therefore, each element used in the construction project may comprise fixed attributes and optional attributes. For each of a plurality of elements, a fixed attribute of an element may be separated from one or more optional attributes of the element. For example, the size (i.e., fixed attribute) of a window to be used in the construction project may be separated from the style, finish and manufacturer options (i.e., optional attributes) for the window. The optional attributes for an element are associated with a corresponding fixed attribute of the element. Estimating a take-off of the elements in the construction project involves estimating costs associated with the fixed and optional attributes of the elements in the construction project.

An initial take-off of the elements may be estimated based on costs associated with the fixed attributes of each element in combination with a selected optional attribute of each element. After the initial take-off, alternate optional attributes may be selected for one or more elements. Alternative take-offs may be estimated based on the fixed attribute of each element in combination with the selected alternate optional attributes corresponding to each element. Alternative take-offs may be estimated whenever optional attributes are changed after the initial takeoff, such as, for example, during the product merchandising stage or at a point of sale with a customer.

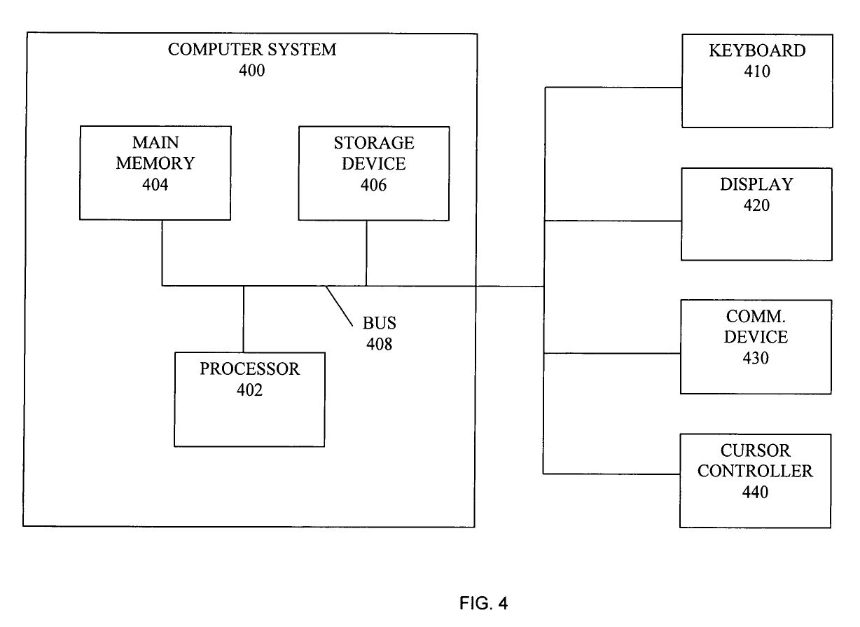

FIG. 4 illustrates an object diagram of a computer system 400 for implementing a system for construction planning according to one embodiment. The computer system 400 may be used, for example, to create an object class and one or more specification classes for each resource in the construction project, as discussed in the embodiments above. Additionally, the computer system 400 may be used to create and maintain a database associating a plurality of specification classes with an object class for each resource, as discussed in the embodiments presented herein. Further, the computer system 400 may be used to estimate take-offs, as described in the embodiments above.

The computer system 400 may include various components, including a processor 402, a main memory 404 and a storage device 406, all of which may be coupled using a bus 408, which facilitates communication between the components of the computer system 400. The main memory 404 may be, for example, a random access memory (RAM) or other dynamic storage device that stores instructions for execution by the processor 402. The storage device 406 may store data and information used in the computer system 400 and may comprise, for example, a hard disk drive, a floppy disk drive, a CD-ROM drive, or other types of non-volatile data storage. The computer system 400 may also include various peripheral devices, including, for example, a keyboard 410, a display 420, a communications device 430 and a cursor controller 440, such as a computer mouse, rollerball or joystick. The display 420 may be used for displaying data and information while the keyboard 410 and cursor controller 440 may be used to input data into the computer system 400. The communications device 430 may be, for example, a modem, and may allow communication with other systems through, for example, conventional land line, wireless and satellite networks using, for example, the Internet, LANs, WANs or MANs.

Although the computer system 400 is depicted with various components, one skilled in the art will appreciate that the computer system 400 may include additional or different components. For example, the computer system 400 may comprise an interconnected network of computers. Computers may be in stand-alone form, such as the traditional desktop personal computer, or integrated into another apparatus, such as a personal digital assistant or a cellular telephone.

The computer system 400 may be specially constructed for the required purposes to perform, for example, the method embodiments presented herein, or the computer system 400 may comprise one or more general purpose computers as selectively activated or reconfigured by a computer program in accordance with the teachings herein stored in the computer(s). The computer system 400 may also be implemented in whole or in part as a hard-wired circuit or as a circuit configuration fabricated into an application-specific integrated circuit. The embodiments presented herein are not inherently related to a particular computer system or other apparatus. The required structure for a variety of these systems will appear from the description given.

The embodiments described above may be implemented as apparent to those skilled in the art in hardware or software, or any combination thereof. The embodiments may be executed on any general computer, such as, for example, a mainframe computer, desktop computer, laptop computer and a portable hand-held computing device. The embodiments may be executed pursuant to one or more program modules or objects generated from any appropriate programming language, such as, for example, C++, Perl, Java and Fortran, and operated using any appropriate operating system, including, for example, Windows or Linux. And still further, each operation, or a file, module, object or the like implementing each operation, may be executed by special purpose hardware or a circuit module designed for that purpose. For example, an embodiment may be implemented as a firmware program loaded into non-volatile storage or a software program loaded from or into a data storage medium as machine-readable code, such code being, instructions executable by an array of logic elements such as a processor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

Embodiments may be implemented as an article of manufacture comprising a computer usable medium having computer readable program code means therein for executing the method operations described above, a program storage device readable by a machine, tangibly embodying a program of instructions executable by a machine to perform the method operations described above, or a computer program product. Such an article of manufacture, program storage device, or computer program product may include, but is not limited to, CD-ROM, CD-R, CD-RW, DVD-ROM, DVD-R, DVD-RAM, DVD-RW, DVD+RW, DVD+R, diskettes, tapes, hard drives, computer system memory (e.g., RAM or ROM), and/or the electronic, magnetic, optical, biological or other similar embodiments of the program (including, but not limited to, a carrier wave modulated, or otherwise manipulated, to convey instructions that can be read, demodulated/decoded and executed by a computer). Indeed, the article of manufacture, program storage device or computer program product may include, any solid or fluid transmission medium, whether magnetic, biological, optical, or the like, for storing or transmitting signals readable by a machine for controlling the operation of a general or special purpose computer according to any or all embodiments described above.

In the case of diagrams depicted, herein, they are provided by way of example. There may be variations to these diagrams or the operations described herein without departing from the spirit of the invention. For instance, in certain cases, the operations may be performed in differing order, or operations may be added, deleted or modified.

While the invention has been described in relation to certain embodiments, it will be understood by those skilled in the art that other embodiments, and modifications to the disclosed embodiments, may be made without departing from the spirit and, scope of the invention. Changes may be made, within the purview of the appended claims, without departing from the scope and spirit of the invention in its aspects. Thus, it should be understood that the above-described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

What is claimed is:

1. A computerized method for construction planning, comprising:
creating an object class for each of a plurality of resources for a construction project, wherein each object class represents an absolute property of each resource, and wherein each resource comprises at least one of material, equipment and labor;
creating one or more specification classes for each resource, wherein the specification classes represent discretionary properties of each resource;
associating each specification class with a corresponding object class for each resource; and
estimating with a computer for the planned construction, a take-off, and estimate of the costs of the plurality of resources based on the object class of each resource, in combination with a selected specification class for each resource.

2. The method of claim 1, further comprising estimating an alternative take-off based on the object class of each resource in combination with an alternate selected specification class for at least one resource.

3. The method of claim 1, wherein each object class corresponds to a cost based on the absolute property corresponding to the object class, and wherein each specification class corresponds to a cost based on a discretionary property corresponding to each specification class.

4. The method of claim 1, further comprising storing the specification classes and the object class for each resource in a database.

5. The method of claim 1, wherein an absolute property comprises size.

6. The method of claim 1, wherein a discretionary property comprises one of:
color, style, finish, manufacturer and installation method.

7. The method of claim 1, further comprising creating one or more packages of specification classes for one or more resources.

8. The method of claim 7, wherein each package comprises a plurality of specification classes sharing a similar level of relative cost with respect to the discretionary properties of each resource.

9. The method of claim 8, further comprising:
selecting a package for one or more resources; and
estimating one or more take-offs for the planned construction of the plurality of resources based on the selected package for each resource and the object class of each resource.

10. The method of claim 9, wherein each object class corresponds to a cost based on the absolute property corresponding to the object class, and wherein each selected package corresponds to a cost based on the discretionary properties corresponding to the specification classes in the selected package.

11. A computerized method for construction planning, comprising:
separating one or more fixed attributes and one or more optional attributes for each of a plurality of elements for a planned construction;
associating selected optional attributes with corresponding fixed attributes for each element; and
estimating with a computer, costs associated with the elements based on the fixed attributes of each element, in combination with a selected optional attribute for each element.

12. The method of claim 11, further comprising estimating alternative costs of the elements based on the fixed attribute of each element in combination with an alternate selected optional attribute for at least one element.

13. The method of claim 11, wherein a fixed attribute comprises size.

14. The method of claim 11, wherein an optional attribute comprises one of: color, style, finish, manufacturer and installation method.

15. A system for construction planning, comprising:
an object class for each of a plurality of resources, wherein each object class represents an absolute property of each resource, and wherein each resource comprises at least one of material, equipment and labor; and
one or more specification classes for each resource, wherein the specification classes represent discretionary properties of each resource, and wherein the specification classes are associated with a corresponding object class for each resource.

16. The system of claim 15, further comprising a take-off of the plurality of resources based on the object class of each resource, in combination with a selected specification class for each resource.

17. The system of claim 15, further comprising a database for storing the specification classes and the object class for each resource.

18. The system of claim 15, wherein an absolute property comprises size.

19. The system of claim 15, wherein a discretionary property comprises one of: color, style, finish, manufacturer and installation method.

20. A computer-readable medium encoded with a plurality of processor-executable instructions for implementing a computerized method for construction planning, the instructions comprising the steps of:
creating an object class for each of a plurality of resources for a construction project, wherein each object class represents an absolute property of each resource, and wherein each resource comprises at least one of material, equipment and labor;
creating one or more specification classes for each resource, wherein the specification classes represent discretionary properties of each resource;
associating each specification class with a corresponding object class for each resource; and
estimating with a computer for the planned construction, a take-off of the costs of the plurality of resources based on the object class of each resource, in combination with a selected specification class for each resource.

21. The computer-readable medium of claim 20, further comprising estimating an alternative take-off based on the object class of each resource in combination with an alternate selected specification class for at least one resource.

22. The computer-readable medium of claim 20, wherein each object class corresponds to a cost based on the absolute property corresponding to the object class, and wherein each specification class corresponds to a cost based on a discretionary property corresponding to each specification class.

23. The computer-readable medium of claim 20, further comprising storing the specification classes and the object class for each resource in a database.

24. The computer-readable medium of claim 20, wherein an absolute property comprises size.

25. The computer-readable medium of claim 20, wherein a discretionary property comprises one of: color, style, finish, manufacturer and installation method.

26. A programmable computer programmed to implement a computerized method for construction planning, comprising:
a main memory for storing instructions; and
a processor in communication with the main memory, the processor operative to utilize the instructions stored in the main memory for:
creating an object class for each of a plurality of resources for a construction project, wherein each object class represents an absolute property of each resource, and wherein each resource comprises at least one of material, equipment and labor;
creating one or more specification classes for each resource, wherein the specification classes represent discretionary properties of each resource;
associating each specification class with a corresponding object class for each resource; and
estimating with a computer for the planned construction, a take-off, and estimate of the costs of the plurality of resources based on the object class of each resource, in combination with a selected specification class for each resource.

27. The programmable computer of claim 26, further comprising estimating an alternative take-off based on the object class of each resource in combination with an alternate selected specification class for at least one resource.

28. The programmable computer of claim 26, wherein each object class corresponds to a cost based on the absolute property corresponding to the object class, and wherein each specification class corresponds to a cost based on a discretionary property corresponding to each specification class.

29. The programmable computer of claim 26, further comprising storing the specification classes and the object class for each resource in a database.

30. The programmable computer claim 26, wherein an absolute property comprises size.

31. The programmable computer of claim 26, wherein a discretionary property comprises one of: color, style, finish, manufacturer and installation method.
